(19) United States
(12) Patent Application Publication
(10) Pub. No.: US 2026/0251281 A1
(43) Pub. Date: Aug. 27, 2026

(54) Device for Backlighting a Partially Transparent Cover

(71) Applicant: Marelli Germany GmbH, Reutlingen (DE)

(72) Inventors: Martin Licht, Reutlingen (DE); Pia Tölle, Reutlingen (DE)

(73) Assignee: Marelli Germany GmbH, Reutlingen (DE)

(21) Appl. No.: 19/464,865

(22) Filed: Jan. 30, 2026

(30) Foreign Application Priority Data
Feb. 27, 2025 (DE) 102025107537.9

(51) Int. Cl. F21S 43/30; B60Q 1/00; B60R 13/00; F21S 43/20; G01S 7/02; G01S 13/931

(52) U.S. Cl. CPC F21S 43/30; B60Q 1/0023; B60R 13/005; F21S 43/265; G01S 7/028; G01S 13/931; G01S 2013/93271

(57) ABSTRACT

A device for backlighting a partially transparent cover. The cover has a planar extension and a logo applied to the cover. The device comprises at least one semiconductor light source arranged on and electrically contacted with a circuit board for emitting light visible to the human eye in a main emission direction and for backlighting the partially transparent cover. The device may include, at an outer edge of the device, at least one reflector with a reflector opening directed towards a central section of the device, to which at least one semiconductor light source is assigned, the main emission direction of the at least one semiconductor light source being oriented towards a reflective surface of the reflector perpendicular or oblique to a surface normal of the circuit board.

### CROSS-REFERENCE TO RELATED APPLICATIONS

The present application claims priority to and all the benefits of German Patent Application No. 102025107537.9, filed on Feb. 27, 2025, the entire contents of which are hereby expressly incorporated herein by reference.

### BACKGROUND OF THE INVENTION

### 1. Field of the Invention

The present invention relates to a device for backlighting a partially transparent cover. The cover has a planar extension and a logo applied to the cover. The device comprises at least one semiconductor light source arranged on a circuit board and electrically contacted for emitting light visible to the human eye in a main emission direction and for backlighting the partially transparent cover.

### 2. Description of the Related Art

Such devices for backlighting a partially transparent cover with a logo are installed, for example, in a radiator grille or a front panel of a motor vehicle. Corresponding devices are known, for example, from U.S. Pat. Nos. 10,081,295 B2 and 7,712,933 B2.

The aim is to illuminate the applied logo by backlighting the cover. The logo itself may be embedded into the cover with a material that is transmissive to the visible light emitted by the semiconductor light sources, or the material of the cover that surrounds the logo may be transmissive to visible light, while the logo itself consists of a material that is not transmissive to visible light.

In addition, the covers are often permeable to radar radiation so that a radar wave emitter located behind the cover can emit radar radiation through the cover into a vehicle environment, in particular into an area in front of the vehicle. The radar wave emitter may be part of a driver assistance system of a motor vehicle.

The object of the present invention is to arrange the at least one reflector of the device together with the at least one assigned semiconductor light source in the device such that, on the one hand, uniform and homogeneous illumination of the logo is ensured, and, on the other hand, space is created inside the device for a radar wave emitter for emitting radar radiation or another light module for emitting visible light, and to ensure that the reflector(s) and the semiconductor light source(s) do not impair the functionality of the radar wave emitter or the other light module.

### SUMMARY OF THE INVENTION

To achieve this object, the present invention is directed toward a device for backlighting a partially transparent cover. The device comprises, at an outer edge of the device, at least one reflector with a reflector opening directed toward a central section of the device, to which at least one semiconductor light source is assigned, wherein the main emission direction of the at least one semiconductor light source is oriented toward a reflective surface of the reflector perpendicular or oblique to a surface normal of the circuit board.

The semiconductor light source is, for example, a light-emitting diode (LED), and in one embodiment, an LED whose main emission direction runs approximately parallel to the planar extension of the circuit board on which the LED is mounted and via which the LED is electrically contacted, or slightly oblique thereto. In one embodiment, the LED is a so-called side-emitting LED (the main emission direction runs approximately perpendicular to a surface normal of the circuit board). In contrast, there are also LEDs whose main emission direction runs at another angle, for example approximately 45°, relative to the surface normal of the circuit board. It is also conceivable for the semiconductor light source to be embodied as a so-called laser diode, such as a laser diode whose main emission direction runs parallel to the planar extension of the circuit board on which the laser diode is mounted and via which the laser diode is electrically contacted, or slightly oblique thereto. In one embodiment, all semiconductor light sources of the device are mounted on the same circuit board. The at least one reflector and the at least one semiconductor light source assigned to it may be mounted on the same circuit board, and the semiconductor light source is electrically contacted via this circuit board. All reflectors and the semiconductor light sources assigned to them may be mounted on the same circuit board, and the semiconductor light sources are electrically contacted via this circuit board.

A particular advantage of the device according to the invention is that the reflectors and the semiconductor light sources inside the device leave space behind the central section of the cover for a radar wave emitter or a light module, which can emit a cone of radar radiation or visible light through the central section of the cover. The lateral arrangement of the reflectors and semiconductor light sources additionally has the advantage that these components do not collide with the emitted cone of radar radiation or visible light and do not shadow or otherwise impair it. As a result, the full functionality of the radar wave emitter or the light module can be ensured with high efficiency.

By using LEDs whose main emission direction runs parallel to the planar extension of the circuit board or oblique thereto, for example side-emitting LEDs, it is prevented that the main emission direction of the visible light runs parallel to the surface normal of the circuit board and that visible light from the LEDs strikes the cover directly from the vicinity of the main emission direction and produces undesirable hotspots there. Rather, this light strikes the cover only indirectly via the reflectors, so that particularly uniform and homogeneous illumination of the logo is ensured.

Furthermore, with the device according to the invention, a particularly large encompassing or surrounding angle of the at least one reflector around the at least one semiconductor light source assigned to it can be achieved. This allows particularly efficient illumination of the logo of the cover with visible light. By using LEDs whose main emission direction runs parallel to the planar extension of the circuit board or oblique thereto, for example side-emitting LEDs, this large surrounding angle can be achieved without the cone of radar radiation or visible light being shadowed by the reflector. In one embodiment, the encompassing angle of the reflector may be at least 60°, or at least 70°, or at least 80°.

The semiconductor light sources may be designed and arranged on the circuit board such that their main emission direction is tilted by approx. 80°-90° relative to the perpendicular normal of the circuit board. This has the advantage that only very little light is emitted by the at least one semiconductor light source in the direction perpendicular to the planar extension of the circuit board, so that even without covering the semiconductor light source with a reflector or shutter, no hotspots appear on the cover to be backlit.

In addition, the efficiency of the backlighting can be improved if the semiconductor light sources are oriented in such a way that they shine directly into their respective assigned reflector. In this way, it can be ensured that every significant light path, on its way to the cover to be backlit, has been reflected at least once by the reflector.

Since, in this way, a very high proportion of the light emitted by the semiconductor light source is captured and used by the assigned reflector and very little light shines undefined into the device, for example into a housing of the device, the proposed device simultaneously enables very efficient illumination of the logo.

In one embodiment of the invention, the device may include several reflectors arranged along the outer edge of the cover, each with a reflector opening directed towards the central section of the cover, each of the reflectors being assigned at least one semiconductor light source, and the main emission directions of the semiconductor light sources being oriented towards the reflective surface of the reflector assigned to the respective semiconductor light source, perpendicular or oblique to the surface normal of the circuit board. Using the plurality of reflectors and semiconductor light sources, the cover can be backlit particularly uniformly and the logo can be illuminated particularly homogeneously. A desired relatively high brightness of the illuminated logo can also be achieved.

According to one embodiment of the invention, the semiconductor light source(s) and the reflector(s) may be designed and oriented relative to one another such that the reflector(s) encompass the semiconductor light source(s) assigned to them to such an extent that the majority of a light cone emitted by the semiconductor light source(s)—either directly or after reflection on the circuit board—strikes the reflective surface of the respective assigned reflector. If at all, light from the lateral edge regions of the light cones emitted by the semiconductor light sources strikes the inner side of the cover directly. This light from the edge regions of the light cone has a lower intensity than the light emitted along the main emission direction. The light emitted along the main emission direction in any case—either directly or after reflection on the circuit board—strikes the reflective surface of the respective assigned reflector and reaches the cover only after at least one reflection on the reflector.

Advantageously, the semiconductor light source(s) and the reflector(s) are designed such that the reflector(s) encompass the semiconductor light source(s) assigned to them to such an extent that the entire light cone emitted by the semiconductor light source(s)—either directly or after reflection on the circuit board—strikes the reflective surface of the respective assigned reflector completely.

According to another advantageous development of the invention, the semiconductor light source(s) and the reflector(s) may be designed and arranged relative to one another such that a front reflector edge of a reflector does not protrude beyond an imaginary plane which is spanned by the surface normal of the circuit board passing through the at least one semiconductor light source assigned to the reflector and a line running perpendicular to the main emission direction of the at least one semiconductor light source assigned to the reflector, passing through the at least one semiconductor light source assigned to the reflector, and extending parallel to the circuit board. All reflectors for illuminating the logo may encompass their respective assigned semiconductor light sources only up to this imaginary plane.

According to another embodiment of the invention, a logo that can be illuminated by backlighting the cover in the motor vehicle sector, such as an illuminable logo of a motor vehicle manufacturer, that is formed on the partially transparent cover. Examples of such a logo include, for example, the Mercedes star, the BMW propeller, the Jaguar head of Jaguar, the diamond of Renault, the prancing horse of Ferrari, or the lion of Peugeot. Of course, the logo in the sense of the present invention may also comprise one or more letters and/or numbers.

According to another advantageous development of the invention, the device may include a housing with an opening which is closed by the partially transparent cover, wherein the at least one reflector with the at least one associated semiconductor light source is arranged inside the housing beneath the cover, for example in front of a side wall of the housing. It is conceivable that several reflectors with correspondingly assigned semiconductor light sources may be arranged along several side walls, for example along all side walls, of the housing. In this way, particularly homogeneous illumination of the logo can be achieved.

Furthermore, it is suggested that at least one partial section, for example the central section, of the partially transparent cover may be designed to be permeable to radar radiation. To this end, it is suggested that beneath the partial section of the partially transparent cover, inside the housing and surrounded by the at least one reflector with the at least one associated semiconductor light source, a radar wave emitter may be arranged and designed such that it emits radar radiation through the partial section of the partially transparent cover. The radar wave emitter may form a part of a driver assistance system of a motor vehicle.

Furthermore, it is suggested that at least one partial section, for example the central section, of the partially transparent cover may be designed to be permeable to light visible to the human eye. To this end, it is suggested that beneath the partial section of the partially transparent cover, inside the housing and surrounded by the at least one reflector with the at least one associated semiconductor light source, a light module (not shown) is arranged and designed such that it emits light visible to the human eye through the partial section of the partially transparent cover. The light emitted by the light module can be used to realize a position or parking light, a daytime running light, or any other lighting function, or a part thereof.

### BRIEF DESCRIPTION OF THE DRAWINGS

Further features and advantages of the present invention are explained in greater detail below with reference to the accompanying drawings. It is emphasized that each individual feature shown in the figures may be essential to the invention on its own, even if this is not explicitly mentioned in the description. Furthermore, the features shown in the figures may be combined with one another in any desired manner, even if such a combination is not explicitly shown in the figures and not explicitly mentioned in the description. The figures show:

FIG. 1 shows a top view into the interior of a device according to the invention without an backlit cover;

FIG. 2 shows a side view in a vertical section through a device according to the invention with a backlit cover;

FIG. 3 shows a side view onto a reflector and a semiconductor light source of a device according to the invention for backlighting a cover of the device in a first embodiment;

FIG. 4 shows a side view onto a reflector and a semiconductor light source of a device according to the invention for backlighting a cover of the device in a second embodiment;

FIG. 5 shows a side view onto a reflector and a semiconductor light source of a device according to the invention for backlighting a cover of the device in a third embodiment;

FIG. 6 shows a side view onto a reflector and a semiconductor light source of a device according to the invention for backlighting a cover of the device in the third embodiment;

FIG. 7 shows a cross-section through a first exemplary structure of a cover backlit by the device;

FIG. 8 shows a cross-section through a second exemplary structure of a cover backlit by the device; and

FIG. 9 shows a motor vehicle having a cover backlit by the device according to the invention in a radiator grille of the vehicle.

### DETAILED DESCRIPTION OF THE INVENTION

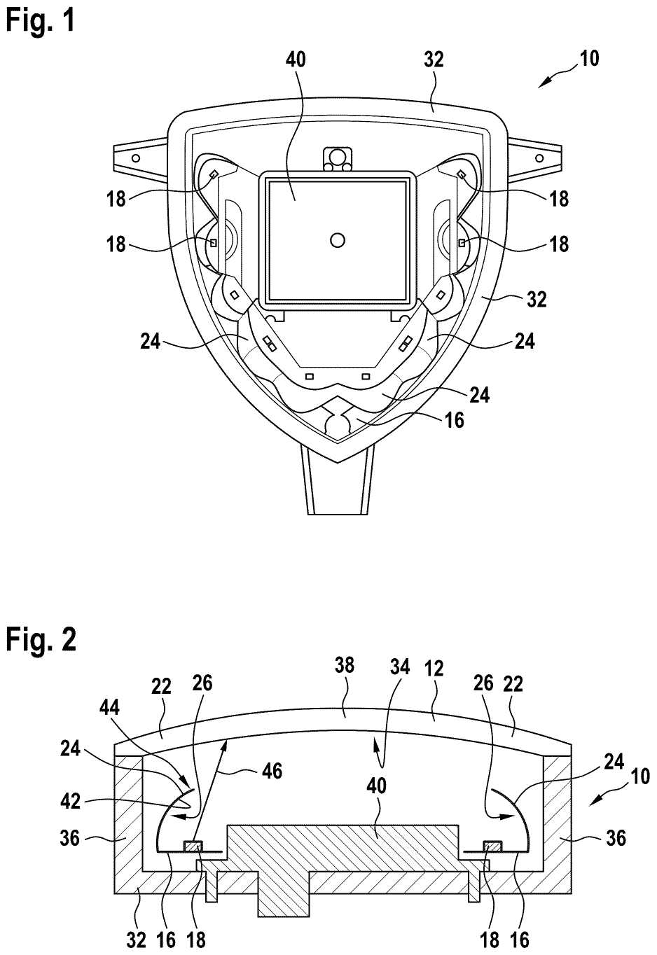

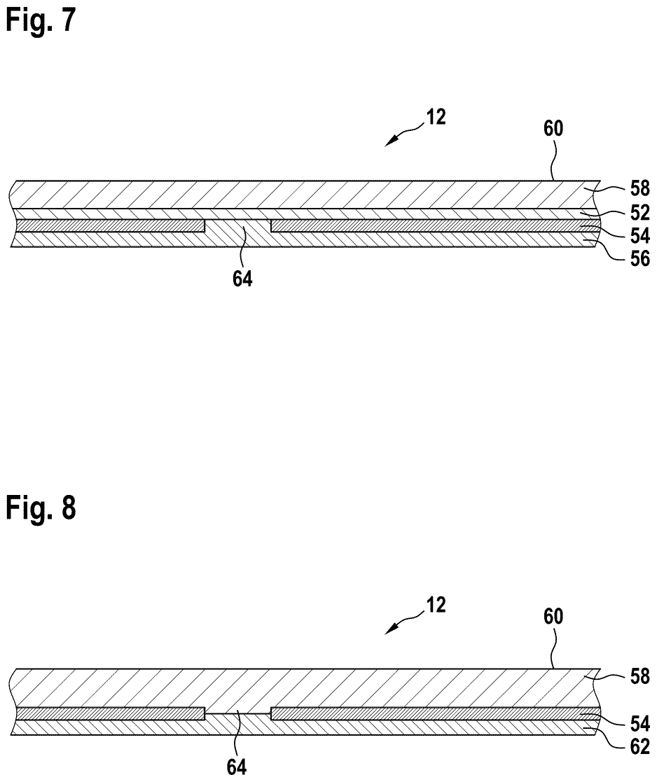

The device 10 shown by way of example in FIG. 1 serves to backlight a partially transparent cover (or cover plate) 12 (see FIG. 2). The cover 12 has a planar extension and a logo 14 applied to the cover 12. The logo 14 itself may be embedded in the cover 12 using a material that is transmissive to visible light, either clear or scattering. The clear or scattering light-transmissive material may also be at least partially tinted. When the cover 12 is backlit, the logo 14 then illuminates by virtue of the light-transmissive material. Alternatively, material of the cover 12 adjacent to the logo 14 may consist of a material that is transmissive to visible light, clear or scattering and/or at least partially tinted, such that, when the cover 12 is backlit, the contours of the logo 14 illuminate while the logo 14 itself remains dark. Examples of a concrete structure of the cover 12 are explained in more detail below with reference to FIGS. 7 and 8.

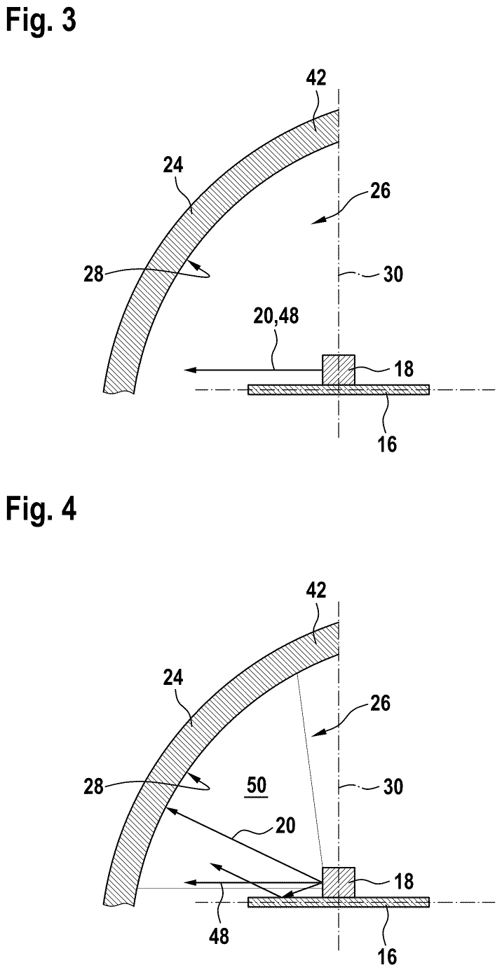

The device 10 comprises at least one semiconductor light source 18 arranged on and electrically contacted with a circuit board 16 for emitting light visible to the human eye in a main emission direction 20 and for backlighting the partially transparent cover 12. The device 10 may include, at an outer edge of the device 10 and/or beneath an outer edge 22 of the cover 12, at least one reflector 24 having a reflector opening 26 directed toward a central section of the device 10 and/or of the cover 12, to which at least one semiconductor light source 18 is assigned. The main emission direction 20 of the at least one semiconductor light source 18 may be oriented toward a reflective surface 28 of the reflector 24 perpendicular to a surface normal 30 of the circuit board 16 (see FIG. 3) or oblique thereto (see FIG. 4).

The device 10 shown in FIG. 1 has, in top view, the shape of a heraldic shield. Naturally, the device 10 could also have any other desired shape, for example a rectangular, a square, an elliptical, a round, circular, or a polygonal, or an equilateral polygonal shape. The semiconductor light sources 18 are arranged closer to the center of the device 10 than the reflectors 24 assigned to them. The main emission directions 20 of the semiconductor light sources 18 may extend outward with respect to the device 10, for example radially outward.

The devices 10 of FIGS. 1 and 2 may each include a housing 32 with an opening 34 that is closed by the partially transparent cover 12. Several reflectors 24 with the at least one semiconductor light source 18 assigned to each reflector are arranged inside the housing 32 beneath the cover 12, for example in front of one or more side walls 36 of the housing 32. The reflectors 24 may be arranged as far radially outward as possible in the housing 32.

Furthermore, it is suggested that at least a partial section 38, for example a central section, of the partially transparent cover 12 may be designed to be permeable to radar radiation. It is also conceivable that the entire cover 12 is made from a material permeable to radar radiation, i.e. the partial section 38 comprises the entire cover 12. Beneath the partial section 38 of the partially transparent cover 12, inside the housing 32 and surrounded by the reflectors 24 with the at least one semiconductor light source 18 assigned to each reflector, a radar wave emitter 40 may be arranged and configured such that it emits radar radiation through the partial section 38 or through the entire partially transparent cover 12. The radar wave emitter 40 may form a part of a driver assistance system of a motor vehicle.

Alternatively or additionally, at least a partial section 38, for example the central section, of the partially transparent cover 12 may be designed to be permeable to light visible to the human eye. To this end, it is suggested that beneath the partial section 38 of the partially transparent cover 12, inside the housing 32 and surrounded by the reflectors 24 with the at least one semiconductor light source 18 assigned to each reflector, a light module (not shown) may be arranged and configured such that it emits light visible to the human eye through the partial section 38 of the partially transparent cover 12. The light emitted by the light module may implement a lighting function (e.g. a position or parking light, a daytime running light, etc.), a headlight function (e.g. low beam, high beam, dynamic driving light, etc.), or any other lighting function, or a portion thereof.

Furthermore, it would also be conceivable to provide neither a radar wave emitter 40 nor a light module in the center of the device 10. In this case, the device 10 would merely have the task of backlighting the cover 12 as uniformly as possible and illuminating the logo 14 applied to the cover 12 as homogeneously as possible. Such a device 10 according to the invention could be designed to be particularly compact, in particular to have a particularly low installation height.

The radar wave emitter 40 emits, through the partial section 38 of the partially transparent cover 12, a radar cone in which—apart from the specially shaped cover 12—no components may be located. Therefore, all lighting components for backlighting the cover 12 are arranged outside the radar cone. This applies for example to the reflectors 24, whose front edge 42 should not protrude into the radar cone (see FIGS. 3 and 4). A possible collision point between the front edge 42 of a reflector 24 and the radar cone is identified in FIG. 2 by reference numeral 44.

A front reflector edge 42 recessed further toward the rear does ensure that the lighting components for backlighting the cover 12 are arranged outside the radar cone. However, in the case of front-or top-emitting LEDs, this results in light emitted by the semiconductor light sources 18 reaching the cover 12 directly (for example without reflection on the reflector 24, without coupling into a light guide or scattering optic, etc.) and producing particularly bright light points, which are so-called hotspots. A corresponding direct light path is indicated in FIG. 2 in an exemplary manner by reference numeral 46. In top-emitting LEDs, therefore, light with particularly high intensity that is emitted along the main emission direction 20 (in the case of top-emitting LEDs parallel to the surface normal 30 of the LED-chip or the circuit board 16) reaches the cover 12 directly and produces particularly bright hotspots there.

A front reflector edge 42 extended far forward, or shutters attached there to the reflector 24, cast shadows on the radar cone and impair it. In this case, therefore, there is a conflict of objectives between avoiding hotspots on the cover 12 caused by visible light used for backlighting the cover 12, on the one hand, and operating the radar wave emitter 40 as efficiently as possible (without shadowing the radar cone), on the other hand.

For this reason, the invention proposes using side-emitting LEDs 18 instead of the conventionally used top-emitting LEDs, which are arranged on the circuit board 16 in such a way that they are oriented, with their LED-chip orientation (surface normal of the LED-chip), towards the reflective surface 28 of the respective reflector 24, as shown in the section of FIG. 3. The main emission direction 20 of the LEDs 18 may be identical to the surface normal 48 of the LED-chip (see FIG. 3) or may deviate from it (see FIG. 4).

The reflector 24 encompasses the side-emitting LED 18 up to a maximum of the surface normal 30 passing through the LED 18, which stands perpendicular to the plane of the circuit board 16. More precisely, the reflector 24 may encompass the LED 18 up to an imaginary plane which is spanned by the surface normal 30 and by a normal to the drawing plane of FIG. 3 passing through the LED 18. The normal corresponds to a straight line or line exiting perpendicularly from the LED 18 out of the drawing plane. In the two-dimensional case of FIG. 3, the imaginary plane corresponds to the surface normal 30. In the example of FIG. 6, the imaginary plane 30a deviates from the surface normal 30.

FIG. 4 shows the section of FIG. 3 with a light cone 50 of the semiconductor light source 18 in the 180° half-space facing the reflector 24. It is noticeable that the light cone 50 of the semiconductor light source 18 is completely emitted into the reflector 24. The main emission direction 20 of the light emitted by the semiconductor light source 18 may also deviate by an angle from the LED-chip normal 48, since, for example, reflections on the circuit board 16 may occur that tilt the effective main emission direction 20.

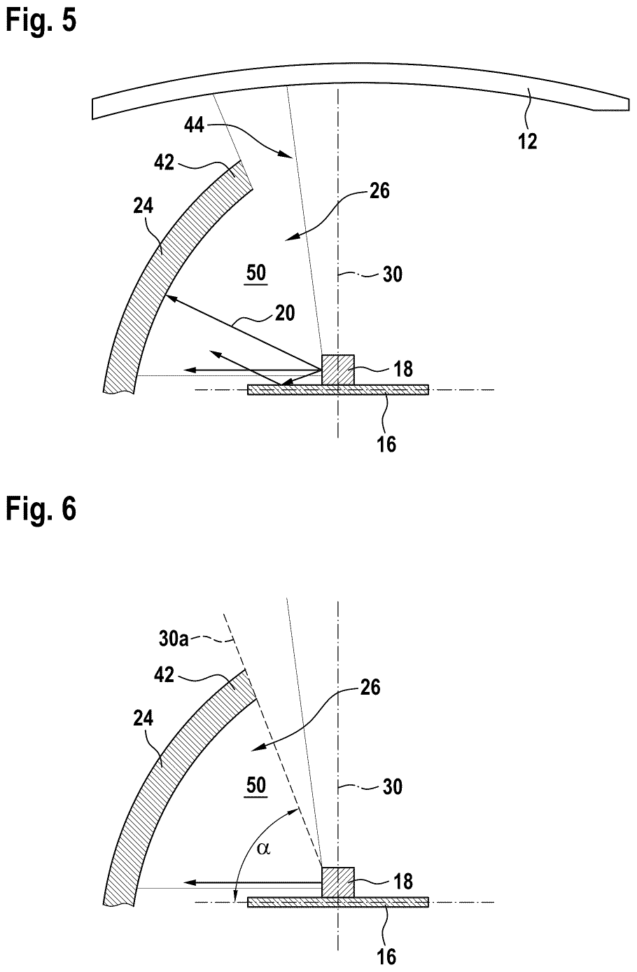

The present invention has the stated advantages even when—as shown in FIG. 5—the light cone 50 is only partially emitted into the reflector 24, because the emission of the semiconductor light source 18 in the critical region near the surface normal 30 has only a small share of the total emission of the LED 18 due to the Lambertian emission characteristic of the LED 18.

In one embodiment, in the critical region 44 of the radar cone, the extent to which the reflector 24 encompasses the semiconductor light source 18 can then be reduced further, and a small part of the light cone 50 may also have a direct path to the cover 12 (see FIG. 5). This light, which reaches the cover 12 directly, originates from the outer edge of the light cone 50 far away from the main emission direction 20 and therefore has only very low energy content (or brightness), so that it does not cause any or only negligible hotspots on the cover 12.

Of course, it is also possible to use the inventive design of the device 10 with side-emitting LEDs 18 only in the region 44 of the radar cone, and to choose a conventional design outside the radar cone, for example with conventional top-emitting LEDs.

Instead of side-emitting LEDs 18, so-called 360° LEDs such as the SYNIOS® P1515 from ams-Osram AG can also be used. These LEDs have an emission characteristic such that less light is emitted in the direction of the surface normal 30 than in the main emission direction 20, but not only into half of a half-space but into the full 180° half-space (360° around the axis 30 around the LED). Thus, there is also a light portion that has a direct path to the cover 12 on the side of the LED facing away from the reflector 24.

A further embodiment of the present invention is shown in FIG. 6. Typical encompassing angles α of the reflector 24 of the device 10 according to the invention are preferably up to 90° (from the planar extension of the circuit board 16 to the surface normal 30 of the circuit board 16). Since the emission characteristic of semiconductor light sources 18 in some cases already ends at approximately 80°, the encompassing angle α may in such a case also be only 80° without disadvantages arising (hotspots caused by visible light, poor efficiency of the radar wave emitter 40, etc.). Should a direct light portion of the semiconductor light source 18 (which reaches the cover 12 directly) be desired or necessary, the encompassing angle α may also be reduced to approximately 60°-70°. In this case—as noted above—no critical hotspots on the cover 12 are to be expected because the direct light portion has only low energy content or low intensity.

For communication or signal lamps in motor vehicles (e.g., turn indicator lights, brake lights, etc.), the use of a side-emitting RGB LED would be advantageous, provided that it exhibits an emission characteristic corresponding to that shown in the figures. Depending on its actuation, an RGB LED can emit red, green, and/or blue light. By superimposing these colors and varying the intensities of the colors, arbitrary intermediate colors of the emitted light can be generated.

As can be seen from FIG. 2, the cover 12 may be designed such that it is as permeable as possible to the radar radiation of a radar wave emitter 40. This may be achieved in that the thickness of the cover 12 is as close as possible to a multiple of half the wavelength of the radar radiation passing through it. In the automotive sector, frequency ranges of approximately 75 GHz are typically used for radar wave emitters 40, corresponding to a wavelength of approximately 4 mm. With the permittivity of the material of the cover 12 (e.g., PC=2.7; PMMA possibly slightly different), an optimum thickness of about 1.15 mm results. To improve manufacturability of the cover 12, a multiple of this value may be used for the thickness, for example a cover plate 12 with a thickness of approximately 2.3 mm.

The cover plate 12 may include a multi-component component, as shown for example in FIG. 7. A transparent carrier foil 52 (e.g., made of PC or PMMA, that may be optionally at least partially tinted, or a multi-layer component) is printed on one side with a design print 54. Subsequently, the entire film 52, 54 is provided with a scattering layer, for example by overprinting again with a white scattering print 56. Thereafter, the film 52, 54, 56 is overmolded on the side facing away from the print 56 with the main material 58 (e.g., PC or PMMA), such that the overall component consisting of foil 52+prints 54, 56+main material 58 has a thickness of approximately 2.3 mm. To protect the component, a protective layer 60 (a so-called hardcoat) with a thickness of approximately 15 μm may be applied to the outer side of the main material 58. By using a screen-printing process, the thickness of the prints 54, 56 can be set in a defined manner, allowing the component thickness to be kept relatively constant. The process described above is also referred to as IMD (in-mold decoration).

An alternative structure results when, instead of a scattering print 56, a scattering film 62 is used as the scattering layer, as shown in FIG. 8.

Light for backlighting the cover 12 can pass through apertures 64 in the design print 54. The apertures 64 are either part of the logo 14 to be illuminated or part of the material of the cover 12 that immediately adjoins the logo 14. In the first case, the logo 14 itself illuminates as a result of the light emitted by the semiconductor light sources 18 and largely redirected (and possibly scattered) by the reflectors 24 and in the second case, the material of the cover 12 surrounding the logo 14 illuminates.

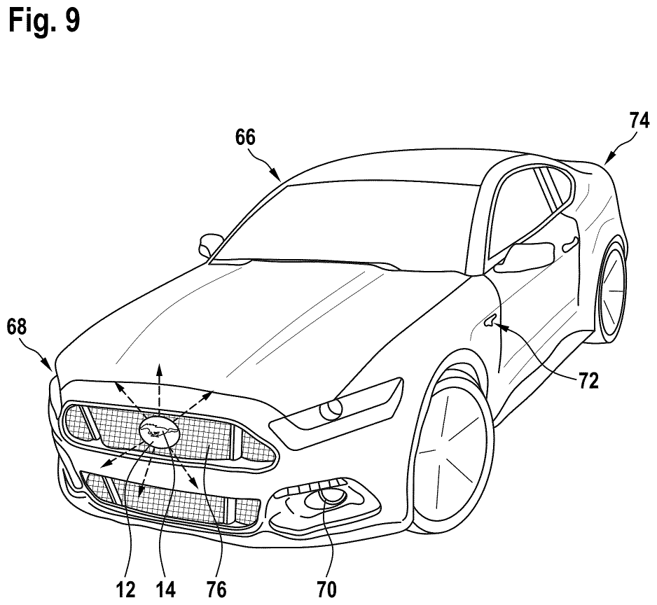

FIG. 9 shows a motor vehicle 66 which, in addition to the generally customary headlamps 68, fog lights 70, side turn indicators 72, and rear lamps 74, includes a radiator grille 76. A cover 12 having a logo 14 is arranged in the radiator grille 76. In this case, the logo 14 is formed, by way of example, as a galloping horse. Behind the cover 12—and therefore not visible in FIG. 9—is a device 10 according to the invention for backlighting the cover 12. In addition to the components 18, 24 for backlighting the cover 12, the device may comprise a radar wave emitter 40 or a light module whose radiation passes through the cover 12 during operation.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. A device for backlighting a partially transparent cover, the cover having a planar extension and a logo applied to the cover, the device comprising at least one semiconductor light source arranged on and electrically contacted with a circuit board for emitting light visible to the human eye in a main emission direction and for backlighting the partially transparent cover
wherein the device comprises, at an outer edge of the device, at least one reflector with a reflector opening directed towards a central section of the device to which at least one semiconductor light source is assigned, the main emission direction of the at least one semiconductor light source being oriented towards a reflective surface of the reflector perpendicular or oblique to a surface normal of the circuit board.

2. The device for backlighting a partially transparent cover as set forth in claim 1, wherein the device further comprises a plurality of reflectors arranged along the outer edge of the device, each with a reflector opening directed towards the central section of the device, each of the reflectors being assigned at least one semiconductor light source and the main emission directions of the semiconductor light sources being oriented towards the reflective surface of the reflector, associated with the respective semiconductor light source, perpendicular or oblique to the surface normal of the circuit board.

3. The device for backlighting a partially transparent cover as set forth in claim 1, wherein the semiconductor light source(s) and the reflector(s) are designed and oriented in respect to each other such that the reflector(s) encompass(es) the semiconductor light source(s) assigned to it/them to such an extent that the majority of a light cone emitted by the semiconductor light source(s)—either directly or after reflection on the circuit board—strikes the reflective surface of the respectively assigned reflector.

4. The device for backlighting a partially transparent cover as set forth in claim 3, wherein the semiconductor light source(s) and the reflector(s) are designed such that the reflector(s) encompass(es) the semiconductor light source(s) assigned to it/them to such an extent that the entire light cone emitted by the semiconductor light source(s)—either directly or after reflection on the circuit board—strikes the reflective surface of the respectively assigned reflector completely.

5. The device for backlighting a partially transparent cover as set forth in claim 3, wherein an encompassing angle (α) of the at least one reflector with respect to the at least one assigned semiconductor light source is at least 60°, or at least 70°, or at least 80°.

6. The device for backlighting a partially transparent cover as set forth in claim 1, wherein the semiconductor light source(s) and the reflector(s) are designed and arranged in respect to each other such that a front reflector edge of a reflector does not extend beyond an imaginary plane defined by the surface normal of the circuit board passing through the at least one semiconductor light source assigned to the reflector, and by a line extending parallel to the circuit board and running perpendicular to the main emission direction of the at least one semiconductor light source assigned to the reflector, through the at least one semiconductor light source assigned to the reflector.

7. The device for backlighting a partially transparent cover as set forth in claim 1, wherein a logo that can be illuminated by the backlighting of the cover is formed on the partially transparent cover, said logo being used in the motor vehicle sector, in particular an illuminable logo of a motor vehicle manufacturer.

8. The device for backlighting a partially transparent cover as set forth in claim 1, wherein the device further comprises a housing with an opening that can be closed by the partially transparent cover, and wherein the at least one reflector with the at least one associated semiconductor light source assigned to it is arranged inside the housing beneath the partially transparent cover.

9. The device for backlighting a partially transparent cover as set forth in claim 1, wherein at least a partial section of the partially transparent cover is designed to be permeable to radar radiation.

10. The device for backlighting a partially transparent cover as set forth in claim 9, wherein beneath the partial section the partially transparent cover inside the housing, and surrounded by the at least one reflector with the at least one semiconductor light source assigned to it, a radar wave emitter is arranged and configured such that it emits radar radiation through the partial section of the partially transparent cover.

11. The device for backlighting a partially transparent cover as set forth in claim 10, wherein the radar wave emitter is part of a driver assistance system of a motor vehicle.

12. The device for backlighting a partially transparent cover set forth in claim 1, wherein at least a partial section of the partially transparent cover is designed to be permeable to light visible to the human eye.

13. The device for backlighting a partially transparent cover as set forth in claim 12, wherein beneath the partial section of the partially transparent cover, inside the housing, and surrounded by the at least one reflector with the at least one semiconductor light source assigned to it, a light module is arranged and configured such that it emits light visible to the human eye through the partial section of the partially transparent cover.

14. The device for backlighting a partially transparent cover as set forth in claim 2, wherein the semiconductor light source(s) and the reflector(s) are designed and oriented in respect to each other such that the reflector(s) encompass(es) the semiconductor light source(s) assigned to it/them to such an extent that the majority of a light cone emitted by the semiconductor light source(s)—either directly or after reflection on the circuit board—strikes the reflective surface of the respectively assigned reflector.

15. The device for backlighting a partially transparent cover as set forth in claim 14, wherein the semiconductor light source(s) and the reflector(s) are designed such that the reflector(s) encompass(es) the semiconductor light source(s) assigned to it/them to such an extent that the entire light cone emitted by the semiconductor light source(s)—either directly or after reflection on the circuit board—strikes the reflective surface of the respectively assigned reflector completely.

16. The device for backlighting a partially transparent cover as set forth in claim 4, wherein an encompassing angle (α) of the at least one reflector with respect to the at least one assigned semiconductor light source is at least 60°, or least 70°, or at least 80°.

17. The device for backlighting a partially transparent cover as set forth in claim 2, wherein the semiconductor light source(s) and the reflector(s) are designed and arranged in respect to each other such that a front reflector edge of a reflector does not extend beyond an imaginary plane defined by the surface normal of the circuit board passing through the at least one semiconductor light source assigned to the reflector, and by a line extending parallel to the circuit board and running perpendicular to the main emission direction of the at least one semiconductor light source assigned to the reflector, through the at least one semiconductor light source assigned to the reflector.

18. The device for backlighting a partially transparent cover as set forth in claim 3, wherein the semiconductor light source(s) and the reflector(s) are designed and arranged in respect to each other such that a front reflector edge of a reflector does not extend beyond an imaginary plane defined by the surface normal of the circuit board passing through the at least one semiconductor light source assigned to the reflector, and by a line extending parallel to the circuit board and running perpendicular to the main emission direction of the at least one semiconductor light source assigned to the reflector, through the at least one semiconductor light source assigned to the reflector.

19. The device for backlighting a partially transparent cover as set forth in claim 8, wherein the at least one reflector with the at least one associated semiconductor light source assigned to it is arranged inside the housing beneath the cover in front of a side wall of the housing.

20. The device for backlighting a partially transparent cover as set forth in claim 8, wherein at least a partial section of the partially transparent cover is designed to be permeable to radar radiation.

21. The device for backlighting a partially transparent cover as set forth in claim 9, wherein the partial section of the partially transparent cover corresponds to the central section of the device.

22. The device for backlighting a partially transparent cover as set forth in claim 12, wherein the partial section of the partially transparent cover corresponds to the central section of the device.

23. The device for backlighting a partially transparent cover as set forth in claim 13, wherein the partial section of the partially transparent cover corresponds to the central section of the device.

24. The device for backlighting a partially transparent cover as set forth in claim 20, wherein the partial section of the partially transparent cover corresponds to the central section of the device.
